(19) United States
(12) Patent Application Publication
(10) Pub. No.: US 2021/0404840 A1
(43) Pub. Date: Dec. 30, 2021

(54) TECHNIQUES FOR MAPPING USING A COMPACT PAYLOAD IN A MOVABLE OBJECT ENVIRONMENT

(71) Applicant: SZ DJI TECHNOLOGY CO., LTD., Shenzhen (CN)

(72) Inventors: Arjun Sukumar MENON, San Jose, CA (US); Jiexi DU, Shenzhen (CN); Yucheng LIU, Shenzhen (CN); Weifeng LIU, Fremont, CA (US)

(21) Appl. No.: 17/339,674

(22) Filed: Jun. 4, 2021

Related U.S. Application Data
(63) Continuation of application No. PCT/CN2020/098339, filed on Jun. 27, 2020.

(51) Int. Cl. G01C 21/00; H04N 5/247; H04N 5/04; B64C 39/02

(52) U.S. Cl. CPC G01C 21/3852; H04N 5/247; H04N 5/04; B64C 2201/123; G01C 21/3893; G01C 21/3837; B64C 39/024

(57) ABSTRACT

Techniques are disclosed for mapping in a movable object environment. A method of mapping may include obtaining mapping data from a scanning sensor of a compact payload coupled to an unmanned aerial vehicle (UAV) the compact payload comprising the scanning sensor, one or more cameras, and an inertial navigation system (INS) configured to be synchronized using a reference clock signal, obtaining feature data from a first camera of the one or more cameras, obtaining positioning data from the INS, associating the mapping data with the positioning data based at least on the reference clock signal to generate geo-referenced data, and storing the geo-referenced data and the feature data to a removable storage medium.

### CROSS REFERENCE TO RELATED APPLICATIONS

This application is a continuation of International Application PCT/CN2020/098339, filed Jun. 27, 2020, entitled, “TECHNIQUES FOR MAPPING USING A COMPACT PAYLOAD IN A MOVABLE OBJECT ENVIRONMENT” which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosed embodiments relate generally to techniques for mapping and more particularly, but not exclusively, to techniques for real-time mapping in a movable object environment.

### BACKGROUND

Movable objects such as unmanned aerial vehicles (UAVs) can be used for performing surveillance, reconnaissance, and exploration tasks for various applications. Movable objects may carry a payload, including various sensors, which enables the movable object to capture sensor data during movement of the movable objects. The captured sensor data may be rendered on a client device, such as a client device in communication with the movable object via a remote control, remote server, or other computing device.

### SUMMARY

Techniques are disclosed for mapping in a movable object environment. A method of mapping may include obtaining mapping data from a scanning sensor of a compact payload coupled to an unmanned aerial vehicle (UAV). The compact payload may comprise the scanning sensor, one or more cameras, and an inertial navigation system (INS) that are configured to be synchronized using a reference clock signal. The method may further include obtaining feature data from a first camera of the one or more cameras, obtaining positioning data from the INS, associating the mapping data with the positioning data based at least on the reference clock signal to generate geo-referenced data, and storing the geo-referenced data and the feature data to a removable storage medium.

### BRIEF DESCRIPTION OF DRAWINGS

FIG. 1 illustrates an example of a movable object in a movable object environment, in accordance with various embodiments.

FIG. 2 illustrates an example of a movable object architecture in a movable object environment, in accordance with various embodiments.

FIG. 3 illustrates an example of a payload dataflow, in accordance with various embodiments.

FIG. 4 illustrates an example of an adapter apparatus in a movable object environment, in accordance with various embodiments.

FIG. 5 illustrates an example of a payload, in accordance with various embodiments.

FIGS. 6-8 illustrate an example of a payload mounted to a movable object, in accordance with various embodiments.

FIG. 9 illustrates an example of overlaying color values in mapping data, in accordance with various embodiments.

FIG. 10 illustrates an example of supporting a movable object interface in a software development environment, in accordance with various embodiments.

FIG. 11 illustrates an example of a movable object interface, in accordance with various embodiments.

FIG. 12 illustrates an example of components for a movable object in a software development kit (SDK), in accordance with various embodiments.

FIG. 13 shows a flowchart of a method of mapping using a compact payload in a movable object environment, in accordance with various embodiments.

### DETAILED DESCRIPTION

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The following description of the invention describes target mapping using a movable object. For simplicity of explanation, an unmanned aerial vehicle (UAV) is generally used as an example of a movable object. It will be apparent to those skilled in the art that other types of movable objects can be used without limitation.

Light detection and ranging (LiDAR) sensors can be used to generate very accurate maps of a target environment. However, LiDAR sensors produce a significant amount of data that is generally not readily viewed by a person right out of the box. Instead, significant configuration of the LiDAR sensor, along with additional sensors such as positioning sensors, along with significant post-processing of the collected data is needed to yield a map that can be usefully interpreted and/or used by a human for various applications. For example, a LiDAR sensor may collect mapping data relative to the LiDAR sensor, and requires a highly accurate inertial navigation system to generate mapping data that can be transformed into a useful coordinate system (e.g., such as a global coordinate system). As such, to obtain useful mapping data, the complexity of the system and the complexity of the post-processing increases quite rapidly along with the cost of all of the components that are needed.

Further, these components are typically not designed for flight. As such, further modifications are needed to mount the components to a suitable unmanned aerial vehicle with sufficient power and a sufficiently sturdy airframe to carry the load of all of these sensors. This, along with cable management, power management, etc. further complicates the setup of a usable UAV-based mapping system.

If such a system is successfully constructed and a mapping mission successfully performed, the user is left with a significant amount of raw data. This raw data must be post-processed into a form that is usable. This post-processing step can take days or weeks to complete depending on the amount of data collected. Additionally, if data is still needed, then additional missions must be flown with additional post-processing time required, before it can be determined if all the needed data has been collected.

Embodiments enable a movable object to map a target environment using a compact payload (also referred to herein as a “payload”) that comprises a plurality of sensors. For example, the compact payload can include a scanning sensor, one or more cameras, and an inertial navigation system (INS) configured to be synchronized using a reference clock signal. This compact payload can be connected to a UAV through a single port which provides a mechanical mounting point as well as managing power and data communication with the payload. Using an embedded processor, such as a CPU, GPU, FPGA, or other processor or accelerator, the payload can obtain mapping data from the scanning sensor, obtain feature data from a first camera of the one or more cameras, obtain positioning data from the INS, associate the mapping data with the positioning data based at least on the reference clock signal to generate geo-referenced data, and store the geo-referenced data and the feature data to a removable storage medium. In some embodiments, a low-density (e.g., “sparse”) representation of the mapping data can be generated by downsampling the mapping data. This low-density representation can be provided as a live view and displayed on a client device or a mobile device, or other computing device, communicatively coupled to the UAV over a wireless communication system.

In some embodiments, once a scanning mission is complete (e.g., after the UAV has flown a mission, collected mapping data, and returned home) the mapping data can be obtained from a removable media in the payload. For example, a secure digital (SD) card can store the mapping data, be removed from the payload or the UAV, and read by a card reader, or other data interface, of a computing device. The computing device may include a post-processing application and a mapping application. The post-processing application can obtain the feature data and the geo-referenced data from the removable storage medium and generate at least one local map based on the feature data and the geo-referenced data. The post processing application can use the local maps to generate an optimized dense map for which accuracy has been improved and noise has been reduced that has been colorized based on image data collected by at least one camera (e.g., an RGB camera) of the payload. The post-processing application can also change the coordinate system of the dense map based on user input. The resulting dense map can be visualized using the mapping application.

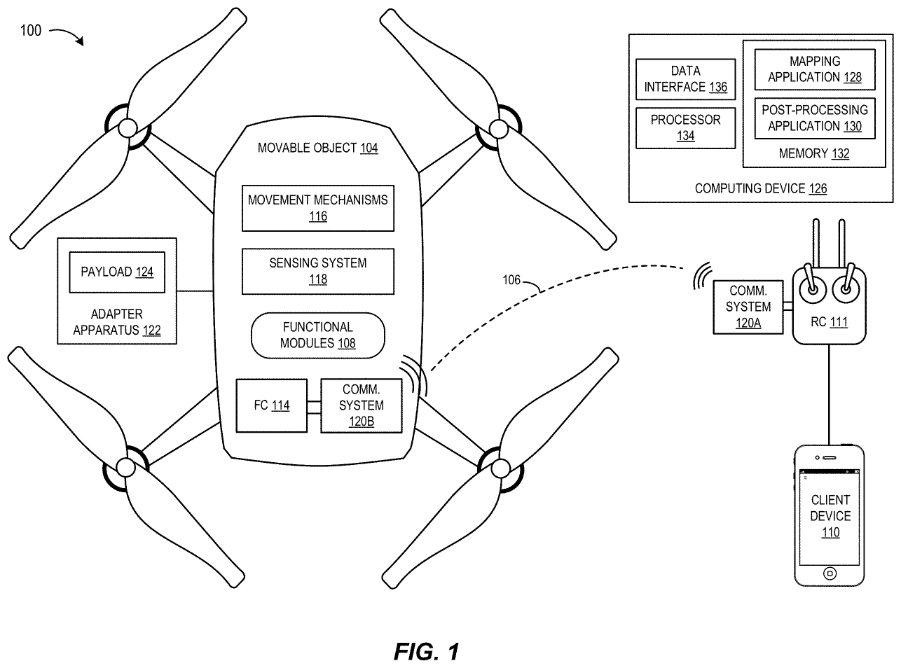

FIG. 1 illustrates an example of a movable object in a movable object environment 100, in accordance with various embodiments. As shown in FIG. 1, client device 110 in a movable object environment 100 can communicate with a movable object 104 via a communication link 106. The movable object 104 can be an unmanned aircraft, an unmanned vehicle, a handheld device, and/or a robot. The client device 110 can be a portable personal computing device, a smart phone, a remote control, a wearable computer, a virtual reality/augmented reality system, and/or a personal computer. Additionally, the client device 110 can include a remote control 111 and communication system 120A, which is responsible for handling the communication between the client device 110 and the movable object 104 via communication system 120B. For example, the communication between the client device 110 and the movable object 104 (e.g., an unmanned aircraft) can include uplink and downlink communication. The uplink communication can be used for transmitting control signals or commands, the downlink communication can be used for transmitting media or video stream, mapping data collected by scanning sensors, or other sensor data collected by other sensors.

In accordance with various embodiments, the communication link 106 can be (part of) a network, which is based on various wireless technologies, such as the WiFi, Bluetooth, 3G/4G, and other radio frequency technologies. Furthermore, the communication link 106 can be based on other computer network technologies, such as the internet technology, or any other wired or wireless networking technology. In some embodiments, the communication link 106 may be a non-network technology, including direct point-to-point connections such as universal serial bus (USB) or universal asynchronous receiver-transmitter (UART).

In various embodiments, movable object 104 in a movable object environment 100 can include an adapter apparatus 122 and a payload 124, such as a scanning sensor (e.g., a LiDAR sensor), camera(s), and/or a collection of sensors in a single payload unit. In various embodiments, the adapter apparatus 122 includes a port for coupling the payload 124 to the movable object 104 which provides power, data communications, and structural support for the payload 124. Although the movable object 104 is described generally as an aircraft, this is not intended to be limiting, and any suitable type of movable object can be used. One of skill in the art would appreciate that any of the embodiments described herein in the context of aircraft systems can be applied to any suitable movable object (e.g., a UAV). In some instances, the payload 124 may be provided on the movable object 104 without requiring the adapter apparatus 122.

In accordance with various embodiments, the movable object 104 may include one or more movement mechanisms 116 (e.g., propulsion mechanisms), a sensing system 118, and a communication system 120B. The movement mechanisms 116 can include one or more of rotors, propellers, blades, engines, motors, wheels, axles, magnets, nozzles, animals, or human beings. For example, the movable object may have one or more propulsion mechanisms. The movement mechanisms may all be of the same type. Alternatively, the movement mechanisms can be different types of movement mechanisms. The movement mechanisms 116 can be mounted on the movable object 104 (or vice-versa), using any suitable means such as a support element (e.g., a drive shaft). The movement mechanisms 116 can be mounted on any suitable portion of the movable object 104, such on the top, bottom, front, back, sides, or suitable combinations thereof.

In some embodiments, the movement mechanisms 116 can enable the movable object 104 to take off vertically from a surface or land vertically on a surface without requiring any horizontal movement of the movable object 104 (e.g., without traveling down a runway). Optionally, the movement mechanisms 116 can be operable to permit the movable object 104 to hover in the air at a specified position and/or orientation. One or more of the movement mechanisms 116 may be controlled independently of the other movement mechanisms, for example by an application executing on client device 110 or other computing device in communication with the movement mechanisms. Alternatively, the movement mechanisms 116 can be configured to be controlled simultaneously. For example, the movable object 104 can have multiple horizontally oriented rotors that can provide lift and/or thrust to the movable object. The multiple horizontally oriented rotors can be actuated to provide vertical takeoff, vertical landing, and hovering capabilities to the movable object 104. In some embodiments, one or more of the horizontally oriented rotors may spin in a clockwise direction, while one or more of the horizontally oriented rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 104 (e.g., with respect to up to three degrees of translation and up to three degrees of rotation). As discussed further herein, a controller, such as flight controller 114, can send movement commands to the movement mechanisms 116 to control the movement of movable object 104. These movement commands may be based on and/or derived from instructions received from client device 110 or other entity.

The sensing system 118 can include one or more sensors that may sense the spatial disposition, velocity, and/or acceleration of the movable object 104 (e.g., with respect to various degrees of translation and various degrees of rotation). The one or more sensors can include any of the sensors, including GPS sensors, real-time kinematic (RTK) sensors, motion sensors, inertial sensors, proximity sensors, or image sensors. The sensing data provided by the sensing system 118 can be used to control the spatial disposition, velocity, and/or orientation of the movable object 104 (e.g., using a suitable processing unit and/or control module). Alternatively, the sensing system 118 can be used to provide data regarding the environment surrounding the movable object, such as weather conditions, proximity to potential obstacles, location of geographical features, location of manmade structures, and the like.

The communication system 120B enables communication with client device 110 via communication link 106, which may include various wired and/or wireless technologies as discussed above, and communication system 120A. The communication system 120A or 120B may include any number of transmitters, receivers, and/or transceivers suitable for wireless communication. The communication may be one-way communication, such that data can be transmitted in only one direction. For example, one-way communication may involve only the movable object 104 transmitting data to the client device 110, or vice-versa. The data may be transmitted from one or more transmitters of the communication system 120B of the movable object 104 to one or more receivers of the communication system 120A of the client device 110, or vice-versa. Alternatively, the communication may be two-way communication, such that data can be transmitted in both directions between the movable object 104 and the client device 110. The two-way communication can involve transmitting data from one or more transmitters of the communication system 120B of the movable object 104 to one or more receivers of the communication system 120A of the client device 110, and transmitting data from one or more transmitters of the communication system 120A of the client device 110 to one or more receivers of the communication system 120B of the movable object 104.

In some embodiments, an application executing on client device 110 or other computing devices that are in communication with the movable object 104 can provide control data to one or more of the movable object 104, adapter apparatus 122, and payload 124 and receive information from one or more of the movable object 104, adapter apparatus 122, and payload 124 (e.g., position and/or motion information of the movable object, adapter apparatus or payload; data sensed by the payload such as image data captured by one or more payload cameras or mapping data captured by a payload LiDAR sensor; and data generated from image data captured by the payload camera or LiDAR data generated from mapping data captured by the payload LiDAR sensor).

In some embodiments, the control data may result in a modification of the location and/or orientation of the movable object (e.g., via control of the movement mechanisms 116), or a movement of the payload with respect to the movable object (e.g., via control of the adapter apparatus 122). The control data from the application may result in control of the payload, such as control of the operation of scanning sensor 124, a camera or other image capturing device (e.g., taking still or moving pictures, zooming in or out, turning on or off, switching imaging modes, changing image resolution, changing focus, changing depth of field, changing exposure time, changing viewing angle or field of view, adding or removing waypoints, etc.).

In some instances, the communications from the movable object, adapter apparatus and/or payload may include information obtained from one or more sensors (e.g., of the sensing system 118 or of the scanning sensor 124 or other payload) and/or data generated based on the sensing information. The communications may include sensed information obtained from one or more different types of sensors (e.g., GPS sensors, RTK sensors, motion sensors, inertial sensors, proximity sensors, or image sensors). Such information may pertain to the position (e.g., location, orientation), movement, or acceleration of the movable object, adapter apparatus, and/or payload. Such information from a payload may include data captured by the payload or a sensed state of the payload.

In some embodiments, the movable object 104 and/or payload 124 can include one or more processors, such as CPUs, GPUs, field programmable gate arrays (FPGAs), system on chip (SoC), application-specific integrated circuit (ASIC), or other processors and/or accelerators. As discussed, the payload may include various sensors integrated into a single payload, such as a LiDAR sensor, one or more cameras, an inertial navigation system, etc. The payload can collect sensor data that is used to provide LiDAR-based mapping for various applications, such as construction, surveying, target inspection, etc. In some embodiments, lower resolution maps can be generated in real-time and higher resolution maps can be generated by post-processing the sensor data collected by the payload 124.

In various embodiments, once a mapping mission is complete, sensor data may be obtained from the payload 124 and provided to computing device 126 for post-processing. For example, the payload 124 or the movable object 104 that is in communication with the payload 124 via the adapter apparatus 122 may include removable media, such as a secure digital (SD) card or other removable media such as flash memory-based memory devices. The removable media can store sensor data of a mapping mission obtained from the payload 124. In some embodiments, the computing device 126 can be disposed off board the movable object 104, such as at a ground terminal, the remote control 111, the client device 110, or other remote terminals. In such embodiments, the computing device 126 can include a data interface 136, such as a card reader, which can read the sensor data stored on the removable media. In other embodiments, the computing device 126 can be disposed onboard the movable object 104, such as at the payload 124 or within the movable object 104. In such embodiments, the computing device 126 can include a data interface 136, which can read the sensor data from an onboard memory of the payload 124 or the movable object 104, or from the removable media through an onboard card reader. In some embodiments, the computing device 126 can operate on the data stored on the removable media directly or store a local copy, such as in memory 132, on disk (not shown) or other storage location accessible to the computing device 126, such as an attached storage device, network storage location, etc. The computing device 126 can include one or more processors 134, such as CPUs, GPUs, field programmable gate arrays (FPGAs), system on chip (SoC), application-specific integrated circuit (ASIC), or other processors and/or accelerators. As shown, memory 132 can include a mapping application 128 to show visualizations of the post-processed scanning data generated by a post-processing application 130.

As discussed, the sensor data can include scanning data obtained from a LiDAR sensor or other sensor that provides high resolution scanning of a target environment, pose data indicating the attitude of the payload when the scanning data was obtained (e.g., from an inertial measurement unit), and positioning data from a positioning sensor (e.g., a GPS module, RTK module, or other positioning sensor), where the sensors providing the sensor data are all incorporated into a single payload 124. In some embodiments, various sensors incorporated into the single payload 124 can be pre-calibrated based on extrinsic and intrinsic parameters of the sensors and synchronized based on a reference clock signal shared among the various sensors. The reference clock signal may be generated by time circuitry associated with one of the various sensors or a separate time circuitry connecting the various sensors. In some embodiments, the positioning data from the positioning sensor may be updated based on correction data received from a positioning sensor of the movable object 104 which may be included in functional modules 108, sensing system 118, or a separate module coupled to movable object 104 which provides positioning data for the movable object. The scanning data can be geo-referenced using the positioning data and used to construct the map of the target environment.

The geo-referenced scanning data and the payload pose data can be provided to the post-processing application 130 for post-processing into a human readable form, as discussed further below. In some embodiments, the post-processing application 130 can output an optimized map as a LiDAR Data Exchange File (LAS) which may be used by various tools, such as mapping application 128, to render the map of the target environment and/or use the mapping data for further processing, planning, etc. Metadata embedded in the LAS output file can facilitate integration of the map with various third-party tools. In various embodiments, the map may be output in various file formats depending on user preferences.

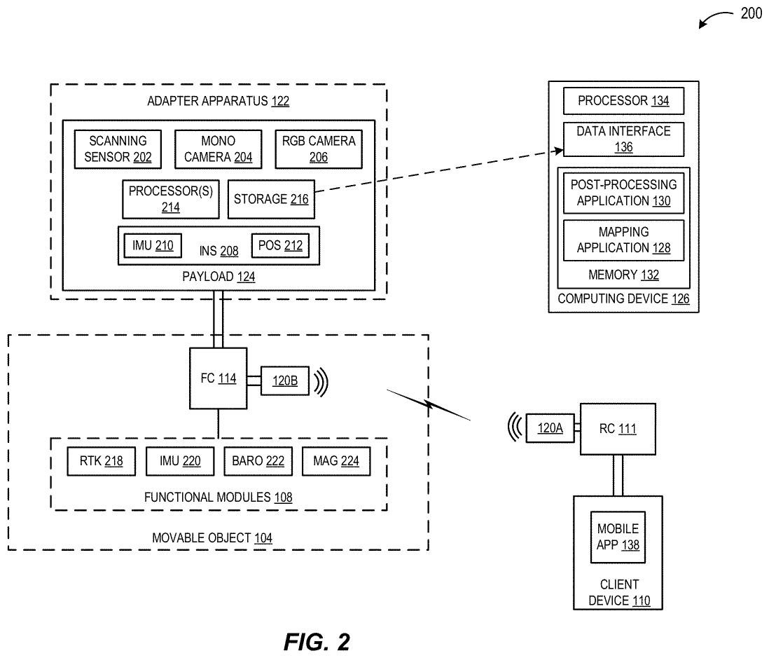

Additional details of the movable object architecture are described below with respect to FIG. 2.

FIG. 2 illustrates an example 200 of a movable object architecture in a movable object environment, in accordance with various embodiments. As shown in FIG. 2, a movable object 104 can include a flight controller 114 that communicates with compact payload 124 via adapter apparatus 122. Additionally, the flight controller can communicate with various functional modules 108 onboard the movable object. As discussed further below, the adapter apparatus 122 can facilitate communication between the flight controller and the payload via a high bandwidth connection, such as Ethernet or universal serial bus (USB). The adapter apparatus 122 can further provide power to the payload 124.

As shown in FIG. 2, the payload may include a plurality of sensors, including a scanning sensor 202, a monocular camera 204, an RGB camera 206, an inertial navigation system 208 which may include an inertial measurement unit 210 and a positioning sensor 212, one or more processors 214, and one or more storage devices 216. For example, scanning sensor 202 may include a LiDAR sensor. The LiDAR sensor may provide high resolution scanning data of a target environment. Various LiDAR sensors may be incorporated into the payload, having various characteristics. For example, the LiDAR sensor may have a field of view of approximately 70 degrees and may implement various scanning patterns, such as a seesaw pattern, an elliptical pattern, a petal pattern, etc. In some embodiments, a lower density LiDAR sensor can be used in the payload, as higher density point clouds require additional processing time. In some embodiments, the payload may implement its components on a single embedded board. The payload may further provide thermal management for the components.

The payload may further include a greyscale monocular camera 204. The monocular camera 204 may include a mechanical shutter that is synchronized with the inertial navigation system (INS) 208 such that when an image is captured by the monocular camera, the attitude of the payload at that moment is associated with the image data. This enables visual features (walls, corners, points etc.) to be extracted from image data captured by the monocular camera 204. For example, the visual features that are extracted can be associated with a pose-timestamp signature that is generated from the attitude data produced by the INS. Using the pose-timestamped feature data, visual features can be tracked from one frame to another, which enables a trajectory of the payload (and as a result, the movable object) to be generated. This allows for navigation in areas with limited signal from satellite-based positioning sensors, such as indoors or when RTK data is weak or otherwise unavailable. In some embodiments, the payload may further include an RGB camera 206. The RGB camera can collect live image data that is streamed to the client device 110 while the movable object is in flight. For example, the user can select whether to view image data collected by one or more cameras of the movable object or the RGB camera of the payload through a user interface of the client device 110. Additionally, color data can be obtained from image data collected by the RGB camera and overlaid on the point cloud data collected by the scanning sensor. This provides improved visualizations of the point cloud data that more closely resemble the actual objects in the target environment being scanned.

As shown in FIG. 2, the payload can further include an inertial navigation system 208. The INS 208 can include an inertial measurement unit 210 and optionally a positioning sensor 212. The IMU 210 provides the attitude of the payload which can be associated with the scanning data and image data captured by the scanning sensor and cameras, respectively. The positioning sensor 212 may use a global navigation satellite service, such as GPS, GLOSNASS, Galileo, BeiDou, etc. In some embodiments, the positioning data collected by the positioning sensor 212 may be enhanced using an RTK module 218 onboard the movable object to enhance positioning data collected by INS 208. In some embodiments, RTK information can be received wirelessly from one or more base stations. The antenna of the RTK module 218 and the payload are separated by a fixed distance on the movable object, allowing the RTK data collected by the RTK module 218 to be transformed into the IMU frame of the payload. Alternatively, the payload 124 may not include its own positioning sensor 212 and instead may rely on a positioning sensor and RTK module 218 of the movable object, e.g., included in functional modules 108. For example, positioning data may be obtained from the RTK module 218 of the movable object 104 and may be combined with the IMU data. The positioning data obtained from the RTK module 218 can be transformed based on the known distance between the RTK antenna and the payload.

As shown in FIG. 2, the payload can include one or more processors 214. The one or more processors may include an embedded processor that includes a CPU and DSP as an accelerator. In some embodiments, other processors may be used such as GPUs, FPGAs, etc. The processors can process sensor data collected by the scanning sensor, cameras, and INS, and generate a live visualization of the sensor data. For example, the processor can geo-reference the scanning data using the INS data. The geo-referenced scanning data can then be downsampled to a lower resolution for visualization on client device 110. The processor(s) 214 can also manage storage of the sensor data to one or more storage devices 216. The storage device(s) can include a secure digital (SD) card or other removable media, a solid state drive (SSD), an eMMC, and/or a memory. In some embodiments, the processor can also be used to perform visual inertial odometry (VIO) using the image data collected by the monocular camera 204. This may be performed in real-time to calculate the visual features which are then stored in a storable format (not necessarily as images) to be used for post processing. In some embodiments, log data may be stored to an eMMC and debugging data can be stored to an SSD. In some embodiments, the processor(s) can include an encoder/decoder built in for processing image data captured by the RGB camera.

The flight controller 114 can send and receive data to and from the remote control via communication system 120B. Flight controller 114 can connect to various functional modules 108, such as RTK module 218, IMU 220, barometer 222, or magnetometer 224. In some embodiments, communication system 120B can connect to other computing devices instead of, or in addition to, flight controller 114. In some embodiments, sensor data collected by the one or more functional modules 108 can be passed from the flight controller 114 to the payload 124.

During a mapping mission, the user can receive data from and provide commands to the UAV using a mobile application 138 on client device 110. The mobile application can display a visualization of the mapping that has been performed so far. For example, the processor(s) 214 can geo-reference the scanning data using the positioning data and then down-sample the resulting geo-referenced mapping data. The down-sampled data can be wirelessly transmitted to the mobile application using communication system 120B via flight controller 114. The mobile application 138 can then display a visual representation of the down-sampled data. This enables a user to visualize how much and/or what portions of a target environment have been scanned to determine what portions still need to be scanned, etc.

Once a mapping mission is complete and the UAV has returned home, the mapping data collected and processed by the payload can be obtained from the removable storage medium on the payload or on the UAV. The removable media can be provided to a computing device 126 where it is read by a data interface 136. For example, where the removable media is an SD card, the data interface 136 may be a card reader. The computing device 126 can include a mapping application 128 to visualize mapping data and a post-processing application 130 to process the raw mapping data into a form that can be visualized. In some embodiments, the post-processing application 130 can be optimized for processing data from the scanning sensor of the payload. Because the payload includes a single scanning sensor having fixed characteristics, the post processing application can be optimized for those characteristics, such as scanning density, etc.

In some embodiments, post-processing may include receiving the geo-referenced point cloud data and the payload pose data and constructing a plurality of local maps. In some embodiments, the local maps may be constructed using an iterative closest matching (ICP) module or other module implementing a matching algorithm. In various embodiments, rather than first extracting features from the scans and using these features to match the scans and build the local maps, the ICP module can operate directly on the point cloud data, improving accuracy and reducing processing times. The local maps can then be analyzed to identify correspondence points. The correspondence points include a point in space that has been scanned multiple times from multiple poses. The correspondence points can be used to construct a pose graph. In some embodiments, the ICP module can identify correspondence points in the local maps using the ICP algorithm. Rather than using the approaches of computing feature points (for example the point feature histograms (PFH), fast point feature histograms (FPFH), 3D scale invariant feature transform (SIFT) feature point or other feature extraction techniques) and then estimating correspondence that are adopted by many point cloud matching techniques, embodiments use ICP to directly determine correspondence without computing human crafted features (e.g., PFH, FPFH, 3D SIFT, etc.). This also avoids potential error that is introduced during the process of abstracting feature information. Graph optimization techniques can then be used to optimize the pose graph to create the optimized point cloud data. The resulting optimized point cloud data can then be viewed on the post-processing application 130 or mapping application 128.

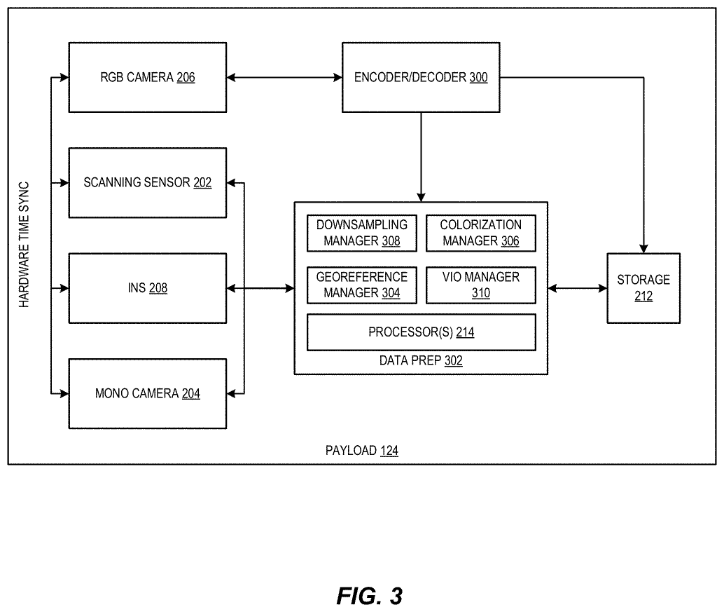

FIG. 3 illustrates an example of a payload dataflow, in accordance with various embodiments. As discussed, the compact payload 124 can include a plurality of integrated sensors, including scanning sensor 202, monocular camera 204, RGB camera 206, and INS 208. As shown in FIG. 3, the sensors of the compact payload can be synchronized using hardware time synchronization circuitry. In some embodiments, one of the plurality of sensors integrated in the compact payload 124 may provide a time signal as a reference clock signal for synchronization. For example, the INS can output a time signal, e.g., a pulse-per-second (PPS) signal, which is received by the other sensors and used to perform a hardware synchronization between the sensors. For example, each sensor can maintain its own local clock which is synchronized based on the time signal from the INS. If the time signal is lost each local clock may slowly drift, leading to inaccurate time stamps. By using a single source of time, the scanning data, image data, attitude data, etc. all share the same timestamps. In some embodiments, a time circuitry separated from the plurality of sensors may provide a time signal as the reference clock signal. In such embodiments, the time circuitry may be connected to the plurality of sensors for transmitting the reference clock signal to other sensors, such that each local clock of each sensor can be synchronized based on the reference clock signal.

As discussed, the payload 124 can include an RGB camera 206. The RGB camera can collect image data during a mapping mission. This image data can be time stamped using the synchronized time signal. The image data collected by the RGB camera can be processed by an encoder/decoder 300. This may be an embedded processor of the payload that includes an encoder/decoder, a DSP, an FPGA, or other processor capable of encoding and decoding image data. The encoder/decoder 300 can provide the image data to a data preparation manager 302 to process along with the other sensor data and can store the image data to storage 212. As discussed, the storage 212 may include media onboard the payload, including removable media and fixed media.

As discussed, the scanning sensor 202 can be a LiDAR sensor that generates 3D points of a target environment (e.g., scanning data). In some embodiments, the scanning data can be time stamped using the synchronized clock values provided by the INS. Additionally, the monocular camera 204 can capture image data that is time stamped on the mechanical shutter being activated in the monocular camera. The INS 208 can provide positioning data, including attitude data of the payload, GPS (or other global navigation satellite service) coordinate data that has been corrected based on RTK data obtained from the movable object, etc. The sensor data can be passed to data preparation manager 302 for further processing.

For example, data preparation manager 302 can include a geo-reference manager 304. The geo-reference manager 304 can obtain the scanning data from the scanning sensor and the positioning data from the INS and generate a geo-referenced mapping data (e.g., geo-referenced point cloud data). In various embodiments, the scanning sensor may produce mapping data in a point cloud format. The point cloud of the mapping data may be a three-dimensional representation of the target environment. In some embodiments, the point cloud of the mapping data may be converted to a matrix representation. The positioning data may include GPS coordinates for the movable object and, in some embodiments, may include roll, pitch, and yaw values associated with the payload corresponding to each GPS coordinate. The roll, pitch, and yaw values may be obtained from the INS which may include an IMU, as discussed, or other sensor. As discussed, the positioning data may be obtained from an RTK module, which corrects the GPS coordinates based on a correction signal received from a reference station. In some embodiments, the RTK module may produce a variance value associated with each output coordinate. The variance value may represent the accuracy of the corresponding positioning data. For example, if the movable object is performing sharp movements, the variance value may go up, indicating less accurate positioning data has been collected. The variance value may also vary depending on atmospheric conditions, leading to different accuracies measured by the movable object depending on the particular conditions present when the data was collected.

In some embodiments, the positioning sensor and scanning sensor may output data with differing delays. For example, the positioning sensor and the scanning sensor may not start generating data at the same time. As such, the positioning data and/or mapping data may be buffered to account for the delay. In some embodiments, a buffer size may be chosen based on the delay between the output of each sensor. In some embodiments, geo-reference manager 304 can receive the data from the positioning sensor and scanning sensor and output geo-referenced data using the timestamps shared by the sensor data with respect to the shared clock signal. This enables the positioning data and mapping data to be synchronized before further processing.

Additionally, the frequency of the data obtained from each sensor may be different. For example, the scanning sensor may be producing data in the range of hundreds of kHz, while the positioning sensor may be producing data in the range of hundreds of Hz. Accordingly, to ensure each point of the mapping data has corresponding positioning data, the lower frequency data can be interpolated to match the higher frequency data. For example, assuming the positioning data is produced by the positioning sensor at 100 Hz and the mapping data is produced by the scanning sensor (e.g., a LiDAR sensor) at 100 kHz, the positioning data may be upsampled from 100 Hz to 100 kHz. Various upsampling techniques may be used to upsample the positioning data. For example, a linear fit algorithm, such as least squares, may be used. In some embodiments, non-linear fit algorithms may be used to upsample the positioning data. Additionally, the roll, pitch, yaw values of the positioning data may also be interpolated to match the frequency of the mapping data, as needed. In some embodiments, the roll, pitch, and yaw values may be spherical linear interpolated (SLERP) to match the number of points in the mapping data. The time stamps may likewise be interpolated to match the interpolated positioning data.

Once the positioning data has been upsampled and synchronized with the mapping data, geo-reference manager 304 can convert a matrix representation of the mapping data from the frame of reference (or the reference coordinate system) in which it was collected (e.g., scanner reference frame or scanner reference coordinate system) to a desired frame of reference (or a desired reference coordinate system). For example, the positioning data may be converted from the scanner reference frame to a north-east-down (NED) reference frame (or a NED coordinate system). The reference frame to which the positioning data is converted may vary depending on the application of the map that is being produced. For example, if the map is being used in surveying, it may be converted to the NED reference frame. For another example, if the map is being used for rendering motions such as flight simulation, it may be converted to the FlightGear coordinate system. Other applications of the map may effect conversions of the positioning data to different reference frames or different coordinate systems.

Each point in the point cloud of the mapping data is associated with a position in the scanner reference frame that is determined relative to the scanning sensor. The positioning data of the movable object, produced by the positioning sensor, may then be used to convert this position in the scanner reference frame to the output reference frame in a world coordinate system, such as a GPS coordinate system. For example, the position of the scanning sensor in the world coordinate system is known based on the positioning data. In some embodiments, the positioning sensor and the scanning module may be offset (e.g., due to being located at different positions on the movable object). In such embodiments, a further correction factoring in this offset may be used to convert from the scanner reference frame to the output reference frame (e.g., each measured position in the positioning data may be corrected using the offset between the positioning sensor and the scanning sensor). For each point in the point cloud of the mapping data, the corresponding positioning data can be identified using the time stamp. The point can then be converted to the new reference frame. In some embodiments, the scanner reference frame can be converted into a horizontal reference frame using the interpolated roll, pitch, and yaw values from the positioning data. Once the mapping data has been converted into the horizontal reference frame, it may be further converted into a Cartesian frame or other output reference frame. Once each point has been converted, the result is a geo-referenced point cloud, with each point in the point cloud now referenced to the world coordinate system. In some embodiments, the geo-referenced point cloud can further be improved by performing outlier removal to remove outlier data from the geo-referenced point cloud.

After the geo-referenced point cloud has been produced, the geo-referenced point cloud data can be colorized by colorization manager 306. For example, the colorization manager can obtain color information from the image data collected by RGB camera 206 and processed by encoder/decoder 300. The color data can be applied to each point in the point cloud based on image data that was captured at the same time as the scanning data based on the shared clock signal. By colorizing the point cloud data, the 3D environment can be better visualized.

In some embodiments, the colorized, geo-referenced point cloud data can be used to generate a sparse map by downsampling manager 308. Downsampling manager 308 can remove outlier data from the point cloud and downsample the point clouds data. Downsampling of this data may be performed using voxels. In some embodiments, the points in each voxel may be averaged, and one or more averaged points may be output per voxel. As such, outlier points will be removed from the data set in the course of averaging the points in each voxel. In various embodiments, the resolution of the voxels (e.g., the size of each voxel), may be arbitrarily defined. In some embodiments, the resolution may be determined by the user, or by the data preparation manager based on, e.g., available computing resources and/or storage space, user preferences, default values, or other application-specific information. For example, a lower resolution (e.g., larger voxel size) may be used to produce a sparse downsampled point cloud for visualization on a client device or a mobile device. The sparse downsampled point cloud data can be stored to storage 212, for example as a LIDAR Data Exchange File (LAS) or other file type to be used with various mapping, planning, analysis, or other tools. In some embodiments, the flight controller can request the sparse downsampled point cloud data from storage 212 and send to a client device for viewing. In some embodiments, the downsampling manager can stream the downsampled point cloud data to the client device via the flight controller. Additionally, the geo-referenced, colorized point cloud data can be stored to the storage 212. The geo-referenced, colorized point cloud data can be post-processed into a high density map by post-processing application 130, as discussed above.

In some embodiments, the data preparation manager 302 can additionally process image data captured by the monocular camera 204. For example, VIO manager 310 can extract visual features in the target environment from the image data. VIO manager 310 can store the visual features and corresponding attitude information as a data structure on storage 212. In some embodiments, the VIO manager can also perform visual inertial odometry (VIO) based on the extracted visual features and the attitude information obtained by the INS. This can be used for navigation of the movable object in areas of weak or no RTK signal by creating a trajectory of the environment based on the movement of the visual features in the image data and changes in attitude of the payload.

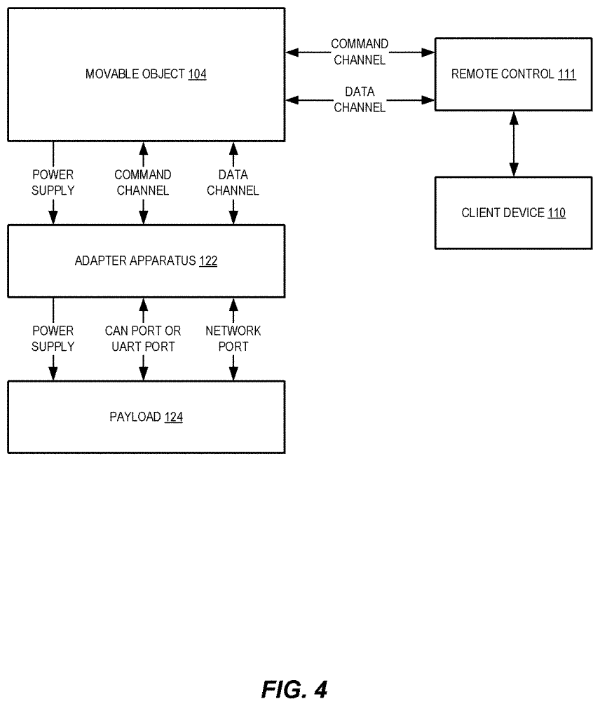

FIG. 4 illustrates an example of an adapter apparatus in a movable object environment, in accordance with various embodiments. As shown in FIG. 4, an adapter apparatus 122 enables a payload 124 to be connected to a movable object 104. In some embodiments, the adapter apparatus 122 is a Payload Software Development Kit (SDK) adapter plate, an adapter ring and the like. The payload 124 can be connected to the adapter apparatus 122, and the adapter apparatus can be coupled with the fuselage of the movable object 104. In some embodiments, adapter apparatus may include a quick release connector to which the payload can be attached/detached.

When the payload 124 is connected to the movable object 104 through the adapter apparatus 122, the payload 124 can also be controlled by a client device 110 via a remote control 111. As shown in FIG. 4, the remote control 111 can send a control instruction through a command channel between the remote control and the communication system of the movable object 104. The control instruction can be transmitted to control the movable object 104 and/or the payload 124. For example, the control instruction may be used for controlling the attitude of the payload, to selectively view live data being collected by the payload (e.g., real-time low density mapping data, image data, etc.) on the client device, etc.

As shown in FIG. 4, after the communication system of the movable object 104 receives the control instruction, the control instruction is sent to the adapter apparatus 122, the communication protocol between the communication system and the adapter apparatus of the movable object is may be referred to as an internal protocol, and the communication protocol between the adapter apparatus and the payload 124 may be referred to as an external protocol. In an embodiment, an internal protocol between the communication system of the movable object 104 and the adapter apparatus 122 is recorded as a first communication protocol, and an external protocol between the adapter apparatus 122 and the payload 124 is recorded as a second communication protocol. After the communication system of the movable object receives the control instruction, a first communication protocol is adopted to send the control instruction to the adapter apparatus through a command channel between the communication system and the adapter apparatus.

When the adapter apparatus receives the control instruction sent by the movable object using the first communication protocol, the internal protocol between the communication system of the movable object and the adapter apparatus is converted into an external protocol between the adapter apparatus and the payload 124. In some embodiments, the internal protocol can be converted into the external protocol by the adapter apparatus by adding a header conforming to the external protocol in the outer layer of the internal protocol message, so that the internal protocol message is converted into an external protocol message.

As shown in FIG. 4, the communication interface between the adapter apparatus and the payload 124 may include a Controller Area Network (CAN) interface or a Universal Asynchronous Receiver/Transmitter (UART) interface. After the adapter apparatus converts the internal protocol between the communication system of the movable object and the adapter apparatus into an external protocol between the adapter apparatus and the payload 124, the control instruction is sent to the payload 124 through the CAN interface or the UART interface by using an external protocol.

As discussed, the payload 124 can collect sensor data from a plurality of sensors incorporated into the payload, such as a LiDAR sensor, one or more cameras, an INS, etc. The payload 124 can send sensor data to the adapter apparatus through a network port between the payload 124 and the adapter apparatus. Alternatively, the payload 124 may also send sensor data through a CAN interface or a UART interface between the payload 124 and the adapter apparatus. Optionally, the payload 124 sends the sensor data to the adapter apparatus through the network port, the CAN interface or the UART interface using a second communication protocol, e.g., the external protocol.

After the adapter apparatus receives the sensor data from the payload 124, the adapter apparatus converts the external protocol between the adapter apparatus and the payload 124 into an internal protocol between the communication system of the movable object 104 and the adapter apparatus. In some embodiments, the adapter apparatus uses an internal protocol to send sensor data to a communication system of the movable object through a data channel between the adapter apparatus and the movable object. Further, the communication system sends the sensor data to the remote control 111 through the data channel between the movable object and the remote control 111, and the remote control 111 forwards the sensor data to the client device 110.

After the adapter apparatus receives the sensor data sent by the payload 124, the sensor data can be encrypted to obtain encrypted data. Further, the adapter apparatus uses the internal protocol to send the encrypted data to the communication system of the movable object through the data channel between the adapter apparatus and the movable object, the communication system sends the encrypted data to the remote control 111 through the data channel between the movable object and the remote control 111, and the remote control 111 forwards the encrypted data to the client device 110.

In some embodiments, the payload 124 can be mounted on the movable object through the adapter apparatus. When the adapter apparatus receives the control instruction for controlling the payload 124 sent by the movable object, the internal protocol between the movable object and the adapter apparatus is converted into an external protocol between the adapter apparatus and the payload 124, and the control instruction is sent to the payload 124 by adopting an external protocol, so that the third-party device produced by the third-party manufacturer can communicate with the movable object normally through the external protocol, so that the movable object can support the third-party device, and the application range of the movable object is improved.

In some embodiments, to facilitate communication with the payload, the adapter apparatus sends a handshake instruction to the payload 124, and the handshake instruction is used for detecting whether the adapter apparatus and the payload 124 are in normal communication connection or not. In some embodiments, the adapter apparatus can also send a handshake instruction to the payload 124 periodically or at arbitrary times. If the payload 124 does not answer, or the response message of the payload 124 is wrong, the adapter apparatus can disconnect the communication connection with the payload 124, or the adapter apparatus can limit the functions available to the payload.

The adapter apparatus may also comprise a power interface, and the power interface is used for supplying power to the payload 124. As shown in FIG. 4, the movable object can supply power to the adapter apparatus, the adapter apparatus can further supply power to the payload 124, the adapter apparatus may include a power interface through which the adapter apparatus supplies power to the payload 124. In various embodiments, the communication interface between the movable object and the adapter apparatus may include a Universal Serial Bus (USB) interface.

As shown in FIG. 4, the data channel between the communication system of the movable object and the adapter apparatus can be implemented using a USB interface. In some embodiments, the adapter apparatus can convert the USB interface into a network port, such as an Ethernet port. The payload 124 can carry out data transmission with the adapter apparatus through the network port, so that the payload 124 can conveniently use the transmission control protocol to communicate with the adapter apparatus for network communication without requiring a USB driver.

In some embodiments, the interface externally output by the movable object comprises a CAN port, a USB port and a 12V 4 A power supply port. The CAN interface, the USB port and the 12V 4 A power port are respectively connected with the adapter apparatus, the CAN port, the USB port and the 12V 4 A power port are subjected to protocol conversion by the adapter apparatus, and a pair of external interfaces can be generated.

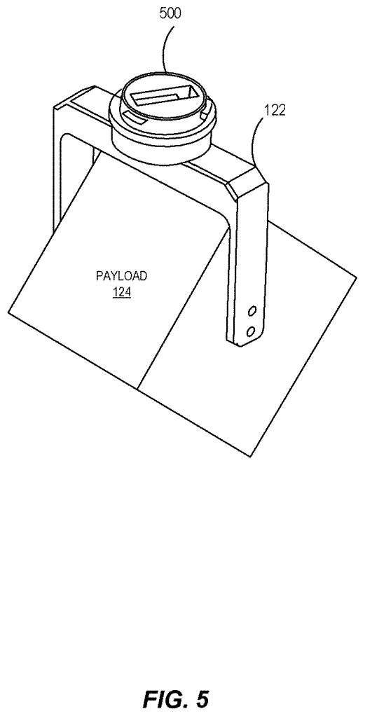

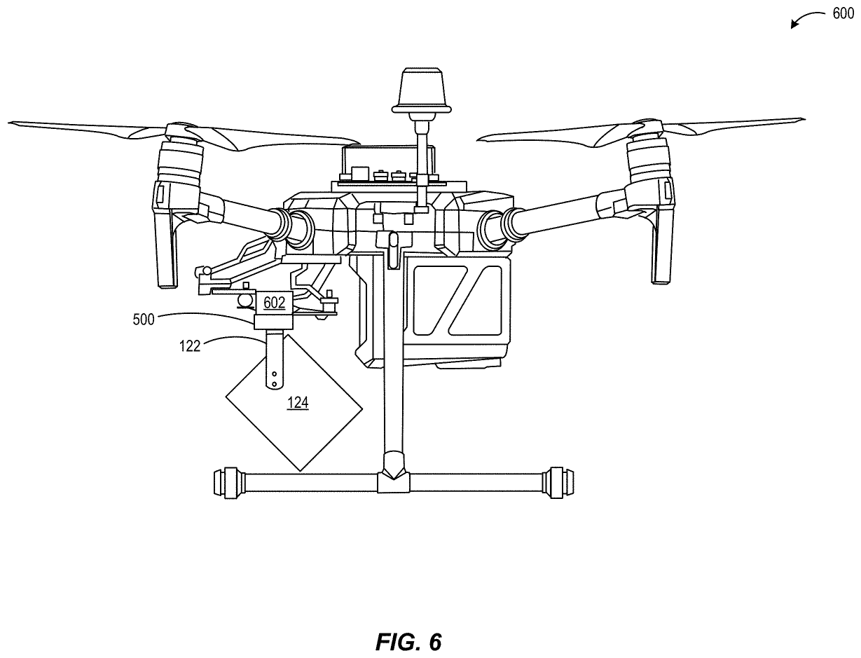

FIG. 5 illustrates an example of a payload, in accordance with various embodiments. As shown in FIG. 5, a payload 124 can be coupled to a movable object via an adapter apparatus 122. The adapter apparatus can include a quick release connector 500 that enables a mechanical connection to be formed with a corresponding quick release connector on the movable object. The quick release connection both physically supports the payload and adapter apparatus by connecting it to the movable object as well as providing power and data communication, as discussed above. In various embodiments, a movable object may be used for performing mapping of various application environments using the compact payload 124. This can include construction site mapping, surveying, target object mapping, etc. In some embodiments, the movable object may be an unmanned aerial vehicle (UAV), which has been configured to perform mapping using the compact payload. FIG. 5 shows an isometric view of the payload 124 and adapter apparatus, in accordance with an embodiment. In various embodiments, commands received by the flight controller from a client device can cause the adapter apparatus 122 to change the angle of the payload 124 as shown below with respect to FIGS. 6-8. The payload may include a gimbal which is used to stabilize the payload in flight and as it changes positions.

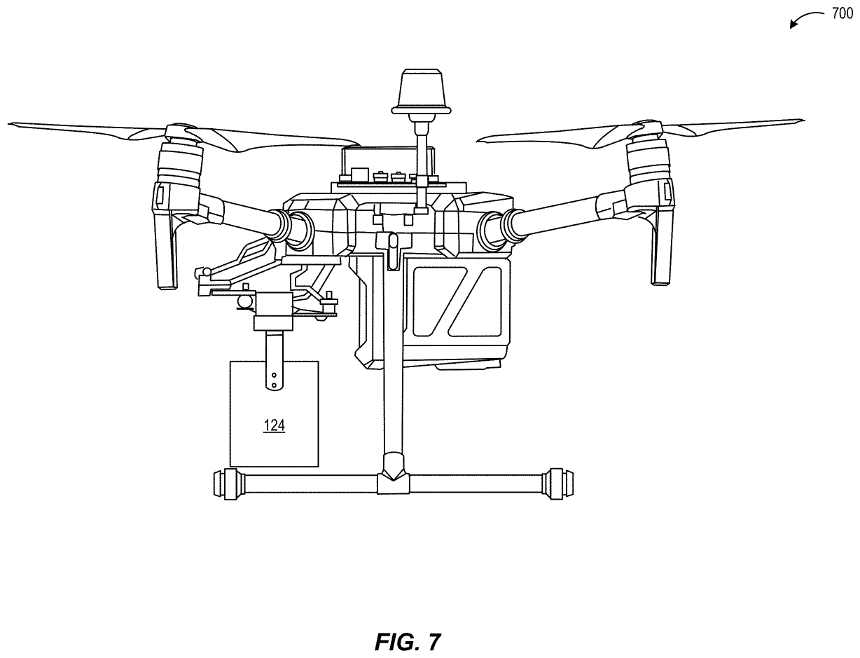

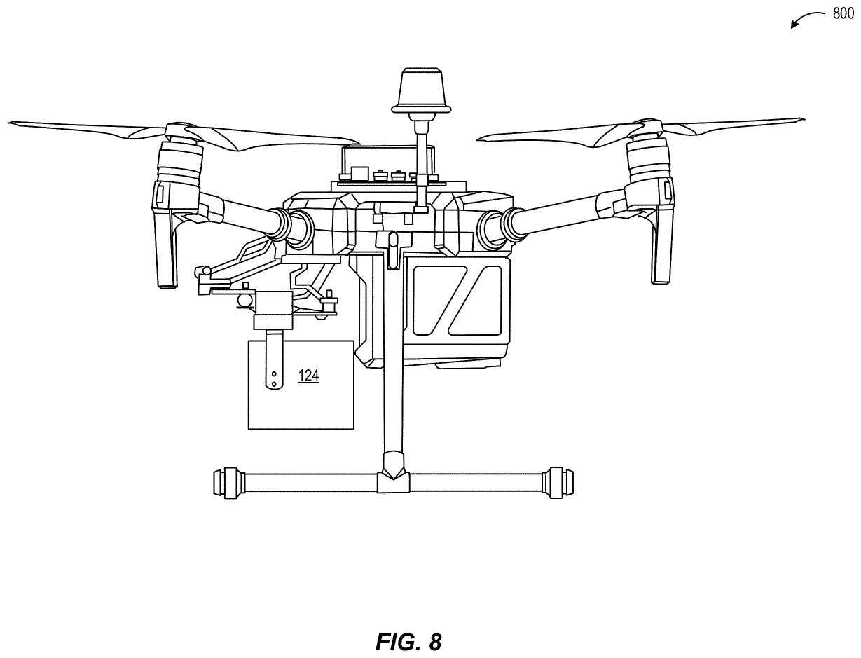

FIGS. 6-8 illustrate an example of a payload mounted to a movable object, in accordance with various embodiments. In the example 600 shown in FIG. 6, the payload 124 can be positioned at 45 degrees relative to horizontal. This position can be achieved using a pivot bracket incorporated into the adapter apparatus 122. In some embodiments, the payload position can be set manually by a user prior to starting a mission or may be controlled remotely by sending commands to the UAV from a client device. As shown, the quick release connector 500 of the adapter apparatus can be mounted to a corresponding quick release connector 602 mounted to the UAV. As discussed, this connection provides physical support to the payload as well as power and data communication. In the example 700 shown in FIG. 7, the payload 124 can be positioned at 0 degrees relative to horizontal. Similarly, the example 800 shown in FIG. 8 shows the payload 124 positioned at 90 degrees relative to horizontal. These positions can be achieved using a pivot bracket incorporated into the adapter apparatus 122, either manually or in response to a command from the client device.

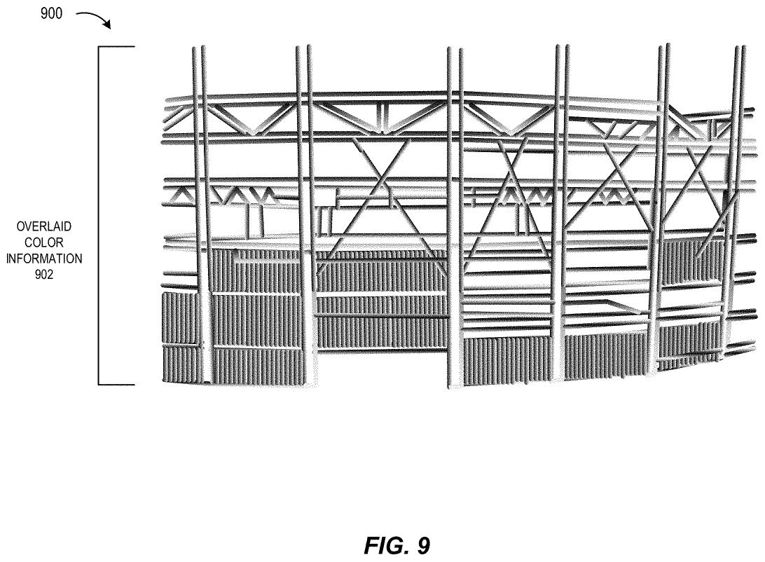

FIG. 9 illustrates an example 900 of overlaying color values in mapping data, in accordance with various embodiments. As shown in FIG. 9, color data can be obtained from the RGB camera incorporated into the payload. This color data may include pixel values of various color schemes (e.g., 16-bit, 32-bit, etc.). The color data can be extracted from one or more images captured by the RGB camera at the same time as the point cloud data was captured by the scanning sensor and these color values can be overlaid 902 on the visualization of the point cloud data. Although depicted in FIG. 9 as grayscale, the color data may include various color values depending on the color values of the image data captured by the RGB camera. Additionally, or alternatively, in some embodiments, the point cloud data can be overlaid on a map of the target area being scanned.

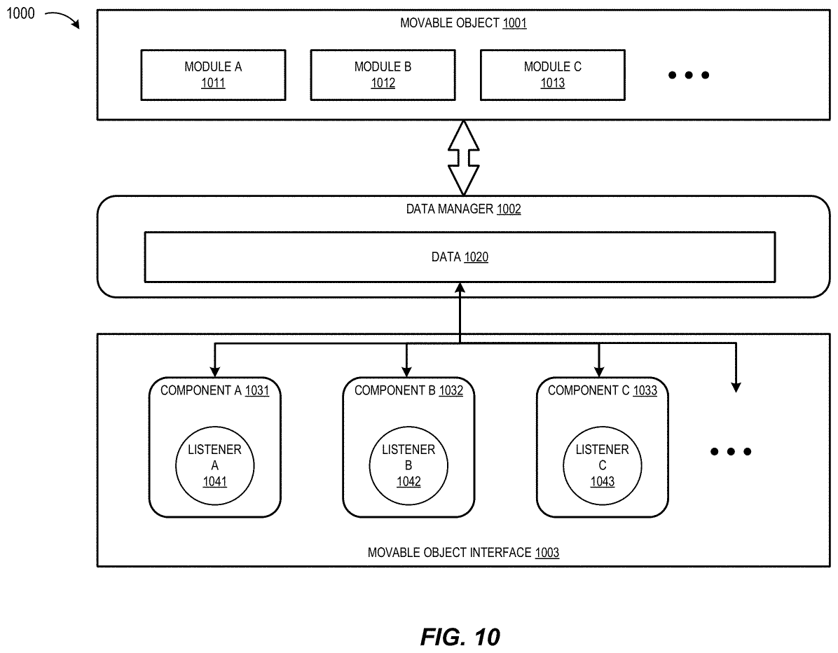

FIG. 10 illustrates an example of supporting a movable object interface in a software development environment, in accordance with various embodiments. As shown in FIG. 10, a movable object interface 1003 can be used for providing access to a movable object 1001 in a software development environment 1000, such as a software development kit (SDK) environment. As used herein, the SDK can be an onboard SDK implemented on an onboard environment that is coupled to the movable object 1001. The SDK can also be a mobile SDK implemented on an off-board environment that is coupled to a client device or a mobile device. Furthermore, the movable object 1001 can include various functional modules A-C 1011-1013, and the movable object interface 1003 can include different interfacing components A-C 1031-1033. Each said interfacing component A-C 1031-1033 in the movable object interface 1003 corresponds to a module A-C 1011-1013 in the movable object 1001. In some embodiments, the interfacing components may be rendered on a user interface of a display of a client device or other computing device in communication with the movable object. In such an example, the interfacing components, as rendered, may include selectable command buttons for receiving user input/instructions to control corresponding functional modules of the movable object.

In accordance with various embodiments, the movable object interface 1003 can provide one or more callback functions for supporting a distributed computing model between the application and movable object 1001.

The callback functions can be used by an application for confirming whether the movable object 1001 has received the commands Also, the callback functions can be used by an application for receiving the execution results. Thus, the application and the movable object 1001 can interact even though they are separated in space and in logic.

As shown in FIG. 10, the interfacing components A-C 1031-1033 can be associated with the listeners A-C 1041-1043. A listener A-C 1041-1043 can inform an interfacing component A-C 1031-1033 to use a corresponding callback function to receive information from the related module(s).

Additionally, a data manager 1002, which prepares data 1020 for the movable object interface 1003, can decouple and package the related functionalities of the movable object 1001. The data manager 1002 may be onboard, that is coupled to or located on the movable object 1001, which prepares the data 1020 to be communicated to the movable object interface 1003 via communication between the movable object 1001 and a client device or a mobile device. The data manager 1002 may be off board, that is coupled to or located on a client device or a mobile device, which prepares data 1020 for the movable object interface 1003 via communication within the client device or the mobile device. Also, the data manager 1002 can be used for managing the data exchange between the applications and the movable object 1001. Thus, the application developer does not need to be involved in the complex data exchanging process.

For example, the onboard or mobile SDK can provide a series of callback functions for communicating instant messages and for receiving the execution results from a movable object. The onboard or mobile SDK can configure the life cycle for the callback functions in order to make sure that the information interchange is stable and completed. For example, the onboard or mobile SDK can establish connection between a movable object and an application on a smart phone (e.g. using an Android system or an iOS system). Following the life cycle of a smart phone system, the callback functions, such as the ones receiving information from the movable object, can take advantage of the patterns in the smart phone system and update the statements accordingly to the different stages in the life cycle of the smart phone system.

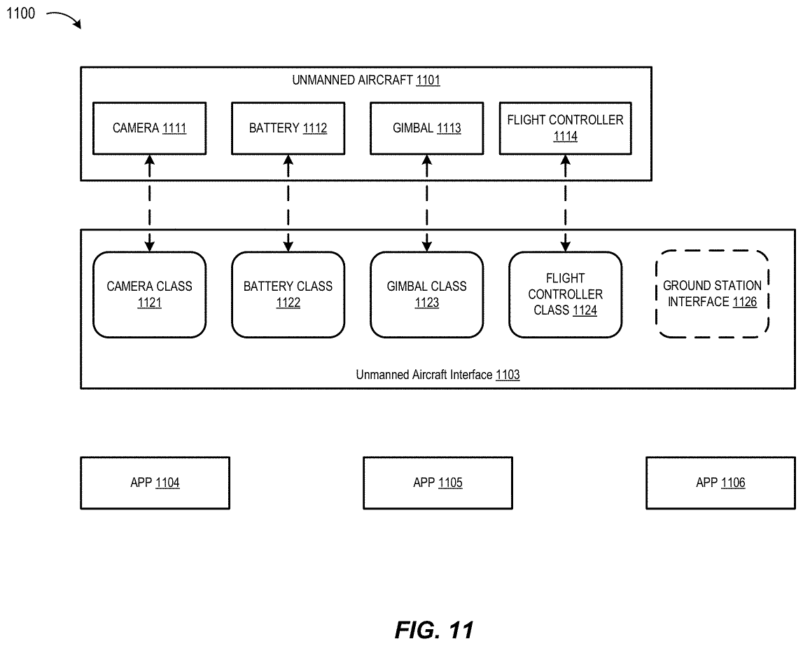

FIG. 11 illustrates an example of a movable object interface, in accordance with various embodiments. As shown in FIG. 11, a movable object interface 1103 can be rendered on a display of a client device or other computing devices representing statuses of different components of a movable object 1101. Thus, the applications, e.g., APPs 1104-1106, in the movable object environment 1100 can access and control the movable object 1101 via the movable object interface 1103. As discussed, these apps may include an inspection app 1104, a viewing app 1105, and a calibration app 1106.

For example, the movable object 1101 can include various modules, such as a camera 1111, a battery 1112, a gimbal 1113, and a flight controller 1114.

Correspondently, the movable object interface 1103 can include a camera component 1121, a battery component 1122, a gimbal component 1123, and a flight controller component 1124 to be rendered on a computing device or other computing devices to receive user input/instructions by way of using the APPs 1104-1106.

Additionally, the movable object interface 1103 can include a ground station component 1126, which is associated with the flight controller component 1124. The ground station component operates to perform one or more flight control operations, which may require a high-level privilege.

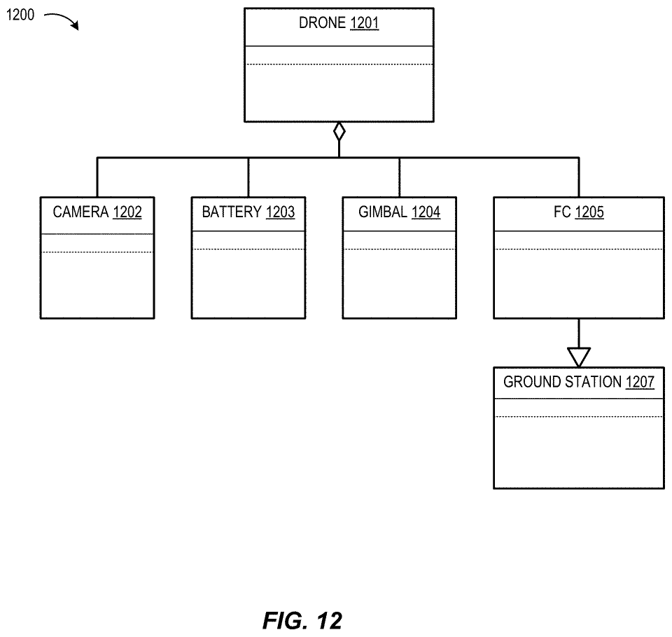

FIG. 12 illustrates an example of components for a movable object in a software development kit (SDK), in accordance with various embodiments. As shown in FIG. 12, the drone class 1201 in the SDK 1200 is an aggregation of other components 1202-1207 for a movable object (e.g., a drone). The drone class 1201, which have access to the other components 1202-1207, can exchange information with the other components 1202-1207 and controls the other components 1202-1207.

In accordance with various embodiments, an application may be accessible to only one instance of the drone class 1201. Alternatively, multiple instances of the drone class 1201 can present in an application.

In the SDK, an application can connect to the instance of the drone class 1201 in order to upload the controlling commands to the movable object. For example, the SDK may include a function for establishing the connection to the movable object. Also, the SDK can disconnect the connection to the movable object using an end connection function. After connecting to the movable object, the developer can have access to the other classes (e.g. the camera class 1202, the battery class 1203, the gimbal class 1204, and the flight controller class 1205). Then, the drone class 1201 can be used for invoking the specific functions, e.g. providing access data which can be used by the flight controller to control the behavior, and/or limit the movement, of the movable object.

In accordance with various embodiments, an application can use a battery class 1203 for controlling the power source of a movable object. Also, the application can use the battery class 1203 for planning and testing the schedule for various flight tasks. As battery is one of the most restricted elements in a movable object, the application may seriously consider the status of battery not only for the safety of the movable object but also for making sure that the movable object can finish the designated tasks. For example, the battery class 1203 can be configured such that if the battery level is low, the movable object can terminate the tasks and go home outright. For example, if the movable object is determined to have a battery level that is below a threshold level, the battery class may cause the movable object to enter a power savings mode. In power savings mode, the battery class may shut off, or reduce, power available to various components that are not integral to safely returning the movable object to its home. For example, cameras that are not used for navigation and other accessories may lose power, to increase the amount of power available to the flight controller, motors, navigation system, and any other systems needed to return the movable object home, make a safe landing, etc.

Using the SDK, the application can obtain the current status and information of the battery by invoking a function to request information from in the Drone Battery Class. In some embodiments, the SDK can include a function for controlling the frequency of such feedback.

In accordance with various embodiments, an application can use a camera class 1202 for defining various operations on the camera in a movable object, such as an unmanned aircraft. For example, in SDK, the Camera Class includes functions for receiving media data in SD card, getting & setting photo parameters, taking photo and recording videos.

An application can use the camera class 1202 for modifying the setting of photos and records. For example, the SDK may include a function that enables the developer to adjust the size of photos taken. Also, an application can use a media class for maintaining the photos and records.

In accordance with various embodiments, an application can use a gimbal class 1204 for controlling the view of the movable object. For example, the Gimbal Class can be used for configuring an actual view, e.g. setting a first personal view of the movable object. Also, the Gimbal Class can be used for automatically stabilizing the gimbal, in order to be focused on one direction. Also, the application can use the Gimbal Class to change the angle of view for detecting different objects.

In accordance with various embodiments, an application can use a flight controller class 1205 for providing various flight control information and status about the movable object. As discussed, the flight controller class can include functions for receiving and/or requesting access data to be used to control the movement of the movable object across various regions in a movable object environment.

Using the Flight Controller Class, an application can monitor the flight status, e.g. using instant messages. For example, the callback function in the Flight Controller Class can send back the instant message every one thousand milliseconds (1000 ms).

Furthermore, the Flight Controller Class allows a user of the application to investigate the instant message received from the movable object. For example, the pilots can analyze the data for each flight in order to further improve their flying skills.

In accordance with various embodiments, an application can use a ground station class 1207 to perform a series of operations for controlling the movable object.

For example, the SDK may require applications to have an SDK-LEVEL-2 key for using the Ground Station Class. The Ground Station Class can provide one-key-fly, on-key-go-home, manually controlling the drone by app (i.e. joystick mode), setting up a cruise and/or waypoints, and various other task scheduling functionalities.

In accordance with various embodiments, an application can use a communication component for establishing the network connection between the application and the movable object.

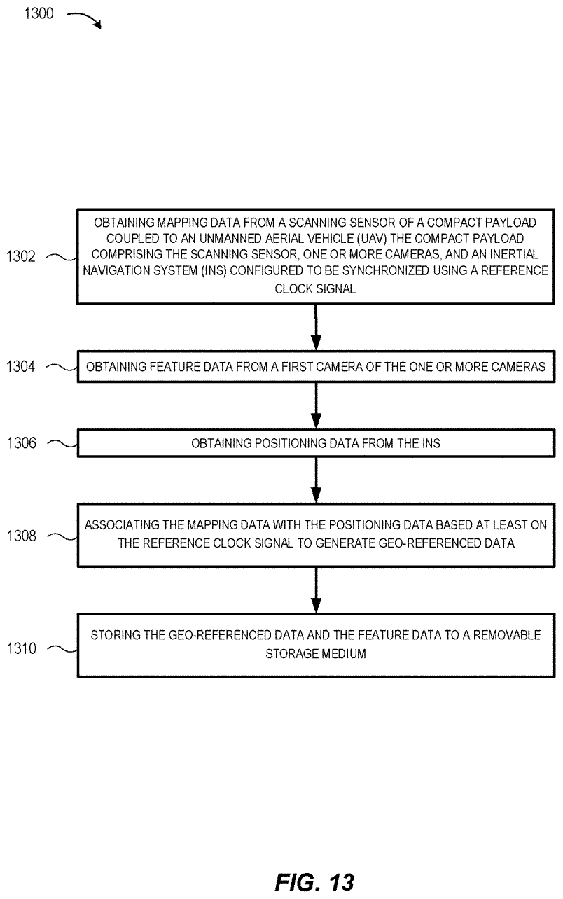

FIG. 13 shows a flowchart of a method of mapping using a compact payload in a movable object environment, in accordance with various embodiments. At operation/step 1302, the method can include obtaining mapping data from a scanning sensor of a compact payload coupled to an unmanned aerial vehicle (UAV), the compact payload comprising the scanning sensor, one or more cameras, and an inertial navigation system (INS) configured to be synchronized using a reference clock signal. In some embodiments, the compact payload is coupled to the UAV via an adapter apparatus which provides power to the compact payload and manages communication of command and/or sensor data between the UAV and the compact payload. In some embodiments, the scanning sensor includes a light detection and ranging (LiDAR) sensor. In some embodiments, the LiDAR sensor has an approximately 70-degree field of view.

At operation/step 1304, the method can include obtaining feature data from a first camera of the one or more cameras. For example, in some embodiments, the first camera is a monocular grayscale camera including a mechanical shutter. The monocular camera may capture image data that is synchronized with the INS of the payload. This allows for features extracted from the image data at different times to be used to determine the trajectory of the payload and the change in position of the payload relative to the features in the image data.

At operation/step 1306, the method can include obtaining positioning data from the INS. In some embodiments, the method may further comprise updating the positioning data obtained from the INS based on second positioning data received from a positioning sensor of the UAV. In some embodiments, the update of the positioning data may be performed based on a calibration relationship between the INS of the compact payload and the positioning sensor of the movable object, such as using a transform based on a distance between the positioning sensor and the compact payload. In some embodiments, the positioning sensor of the UAV may be an RTK sensor. In some embodiments, the INS includes an inertial measurement unit (IMU) sensor. The calibration relationship between the IMU sensor of the compact payload and the RTK sensor of the UAV may be predetermined based on an orientation of the two sensors or a distance between the two sensors.

At operation/step 1308, the method can include associating the mapping data with the positioning data based at least on the reference clock signal to generate geo-referenced data. In some embodiments, the association is based on timestamps of the mapping data and the positioning data generated with respect to the reference clock signal. At operation/step 1310, the method can include storing the geo-referenced data and the feature data to a removable storage medium. In some embodiments, the method may further include associating the geo-referenced data with color data obtained from a second camera (e.g., an RGB camera) of the one or more cameras.

In some embodiments, the method may further include receiving, by a client device or a mobile device communicatively coupled to the UAV, image data from a second camera of the one or more cameras, and displaying, by the client device or the mobile device, the image data including real-time image data representing a point of view of the compact payload. In some embodiments, the method may further include receiving a request to view second image data from a UAV camera, the UAV camera incorporated into the UAV, and displaying the second image data including real-time image data representing a point of view of the UAV.

In some embodiments, the method may further include receiving a representation of the mapping data from the compact payload, and displaying the representation of the mapping data, the representation of the mapping data including a sparse map representation of the mapping data captured by the scanning sensor. In some embodiments, the method may further include overlaying the representation of the mapping data on a GPS map.

In some embodiments, the method may further include obtaining, by a computing device, the feature data and the geo-referenced data from the removable storage medium, and generating, by the computing device, at least one local map based on the feature data and the geo-referenced data. In some embodiments, the method may further include downsampling the mapping data to generate a sparse point cloud for live visualization on a client device or a mobile device.

In some embodiments, calibration is performed between the scanning sensor, the one or more cameras, and the inertial navigation system (INS) based on calibration intrinsic parameters.

Many features can be performed in, using, or with the assistance of hardware, software, firmware, or combinations thereof. Consequently, features may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features can be incorporated in software and/or firmware for controlling the hardware of a processing system, and for enabling a processing system to interact with other mechanism utilizing the results. Such software or firmware may include, but is not limited to, application code, device drivers, operating systems and execution environments/containers.

Features of the invention may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description has been provided for the purposes of illustration and description. It is not intended to be exhaustive or to limit the invention to the precise forms disclosed. The breadth and scope should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

What is claimed is:

1. A system for mapping in a movable object environment, comprising:
an unmanned aerial vehicle (UAV);
a compact payload coupled to the UAV via an adapter apparatus, the compact payload comprising a scanning sensor, one or more cameras, and an inertial navigation system (INS) configured to be synchronized using a reference clock signal;
the compact payload further including at least one first processor and a first memory, the first memory including instructions which, when executed by the at least one first processor, cause the at least one first processor to:
obtain mapping data from the scanning sensor;
obtain feature data from a first camera of the one or more cameras;
obtain positioning data from the INS;
associate the mapping data with the positioning data based at least on the reference clock signal to generate geo-referenced data; and
store the geo-referenced data and the feature data to a removable storage medium.

2. The system of claim 1, wherein the UAV comprises a positioning sensor and wherein the instructions to obtain positioning data from the INS, when executed by the processor, further cause the at least one first processor to:
update the positioning data obtained from the INS based on second positioning data received from the positioning sensor using a transform based on a distance between the positioning sensor and the compact payload.

3. The system of claim 2, wherein the positioning sensor is a real-time kinematic (RTK) sensor.

4. The system of claim 1, further comprising:
a client device comprising at least one second processor and a second memory, the second memory including instructions which, when executed by the at least one second processor, cause the at least one second processor to:
receive image data from a second camera of the one or more cameras; and
display the image data including real-time image data representing a point of view of the compact payload.

5. The system of claim 4, wherein the instructions, when executed, further cause the at least one second processor to:
receive a request to view second image data from a UAV camera, the UAV camera incorporated into the UAV; and
display the second image data including real-time image data representing a point of view of the UAV.

6. The system of claim 4, wherein the instructions, when executed, further cause the at least one second processor to:
receive a representation of the mapping data from the compact payload; and
display the representation of the mapping data, the representation of the mapping data including a sparse map representation of the mapping data captured by the scanning sensor.

7. The system of claim 6, wherein the instructions, when executed, further cause the at least one second processor to:
overlay the representation of the mapping data on a GPS map.

8. A method for mapping in a movable object environment, comprising:
obtaining mapping data from a scanning sensor of a compact payload coupled to an unmanned aerial vehicle (UAV) the compact payload comprising the scanning sensor, one or more cameras, and an inertial navigation system (INS) configured to be synchronized using a reference clock signal;
obtaining feature data from a first camera of the one or more cameras;
obtaining positioning data from the INS;
associating the mapping data with the positioning data based at least on the reference clock signal to generate geo-referenced data; and
storing the geo-referenced data and the feature data to a removable storage medium.

9. The method of claim 8, further comprising:
associating the geo-referenced data with color data obtained from a second camera of the one or more cameras.

10. The method of claim 8, wherein the compact payload is coupled to the UAV via an adapter apparatus which provides power to the compact payload and manages communication of command and/or sensor data between the UAV and the compact payload.

11. The method of claim 8, wherein the scanning sensor includes a light detection and ranging (LiDAR) sensor.

12. The method of claim 11, wherein the LiDAR sensor has an approximately 70-degree field of view.

13. The method of claim 8, wherein the first camera is a monocular grayscale camera including a mechanical shutter.

14. The method of claim 8, wherein the INS includes an inertial measurement unit (IMU) sensor.

15. A non-transitory computer readable storage medium including instructions stored thereon which, when executed by at least one processor, cause the at least one processor to:
obtain mapping data from a scanning sensor of a compact payload coupled to an unmanned aerial vehicle (UAV) the compact payload comprising the scanning sensor, one or more cameras, and an inertial navigation system (INS) configured to be synchronized using a reference clock signal;
obtain feature data from a first camera of the one or more cameras;
obtain positioning data from the INS;
associate the mapping data with the positioning data based at least on the reference clock signal to generate geo-referenced data; and
store the geo-referenced data and the feature data to a removable storage medium.

16. The non-transitory computer readable storage medium of claim 15, wherein the first camera is a monocular grayscale camera including a mechanical shutter.

17. The non-transitory computer readable storage medium of claim 15, wherein the INS includes an inertial measurement unit (IMU) sensor.

18. The non-transitory computer readable storage medium of claim 15, wherein the instructions, when executed, further cause the at least one processor to:
obtain the feature data and the geo-referenced data from the removable storage medium; and
generate at least one local map based on the feature data and the geo-referenced data.

19. The non-transitory computer readable storage medium of claim 15, wherein the instructions, when executed, further cause the at least one processor to:
downsample the mapping data to generate a sparse point cloud for live visualization on a client device.

20. The non-transitory computer readable storage medium of claim 15, wherein calibration is performed between the scanning sensor, the one or more cameras, and the inertial navigation system (INS) based on calibration intrinsic parameters.
